(19) United States
(12) Patent Application Publication
(10) Pub. No.: US 2012/0191354 A1
(43) Pub. Date: Jul. 26, 2012

(54) METHOD FOR DETERMINING STRATIGRAPHIC POSITION OF A WELLBORE DURING DRILING USING COLOR SCALE INTERPRETATION OF STRATA AND ITS APPLICATION TO WELLBORE CONSTRUCTION OPERATIONS

(76) Inventor: Francisco Caycedo, Calgary (CA)

(21) Appl. No.: 13/357,691

(22) Filed: Jan. 25, 2012

Related U.S. Application Data
(60) Provisional application No. 61/498,643, filed on Jun. 20, 2011.
(60) Provisional application No. 61/436,246, filed on Jan. 26, 2011.

(51) Int. Cl. G06F 19/00

(52) U.S. Cl. 702/9

(57) ABSTRACT

A method for formation structural interpretation while drilling a wellbore through subsurface rock formations includes interpreting rock formation strata with respect to measurements of a formation physical property made with respect to depth in an offset wellbore. A color is assigned to each of a plurality of selected value ranges of the measurements. The physical property of the formation is measured while drilling the wellbore through the subsurface rock formations. A color is assigned to the measurements made while drilling based on the assigned color to each of the selected value ranges. The assigned colors made while drilling are used to estimate a stratigraphic position of the wellbore during the drilling by comparing the assigned colors made while drilling to the colors assigned from the offset wellbore.

### CROSS-REFERENCE TO RELATED APPLICATIONS

Priority is claimed from U.S. Provisional Application No. 61/498,643 filed on Jun. 20, 2011 and U.S. Provisional Application No. 61/436,246 filed on Jan. 26, 2011, both of which are incorporated herein by reference in their entirety.

### STATEMENT REGARDING FEDERALLY SPONSORED RESEARCH OR DEVELOPMENT

Not applicable.

### BACKGROUND

The invention relates generally to the field of drilling wellbores through subsurface rock formations. More specifically, the invention relates to methods for determining the stratigraphic position of a wellbore within layered strata for the purpose of placing a well trajectory within selected strata for a selected lateral distance within the strata, and the use of such trajectory determination in wellbore construction and/or completion operations.

Wellbores are drilled through selected subsurface rock formations for, among other purposes, extraction of materials such as oil and gas from the formations. One technique known in the art for increasing the amount of and the rate at which such materials may be recovered from subsurface formations is known as directional drilling. In directional drilling, a wellbore may be initially drilled essentially vertically from the surface, and the trajectory of the wellbore may be changed using one or more types of directional drilling tools and procedures so that the wellbore trajectory follows a selected path.

The selected wellbore path for directional drilling may be predetermined prior to drilling based on interpretation of the structure (geodetic distribution with respect to subsurface depth) of the subsurface formations. Such interpretations may be performed, for example, by interpretation of surface seismic data, data obtained from nearby wellbores and other techniques known in the art.

It is known in the art that such techniques as the foregoing have limited resolution. For example, seismic data obtained by reflection seismic techniques at the earth's surface (or in a body of water in marine seismic surveying) may be limited in vertical resolution. Data obtained from nearby wellbores typically do not have long lateral resolution away from the wellbore from which the data were obtained. Such limitations frequently result in predetermined wellbore trajectories requiring modification during drilling in order to maintain the well trajectory within a selected formation or set of formations.

One of the methods used to maintain the well trajectory within a selected formation or selected formations is known as “geosteering.” Geosteering includes the use of drilling instruments that make measurements of selected physical properties of the formations during the drilling procedure. Such measurements are transmitted to the surface, whereupon the measurements can be interpreted to determine the wellbore position within the various formations (called “strata” because the formations drilled are typically disposed in discrete layers stacked sequentially), and thus the wellbore trajectory may be defined in terms of its stratigraphic position. The measurements may be correlated to the measured depth (axial position) in the wellbore at which they were made by techniques known in the art. Such measurements are frequently referred to as “logging while drilling” (LWD) measurements.

To make the foregoing interpretation of the stratigraphic position of the wellbore, the LWD measurements, which are made in terms of the measured depth, may be transformed to true vertical depth (“TVD” which is the elevation below a surface or other reference) or true stratigraphic thickness (TST) and correlated to representative measurement curves from nearby wellbores. Such transformation may be made possible by using measurements of the wellbore trajectory made during the drilling procedure at the same time the LWD measurements are made. The elevation (TVD) and dip (change of elevation with respect to change in geodetic position) required in the transformation to achieve a match between the LWD measurements and the nearby wellbore type curves may define the structure of the rock formations. Because the well trajectory typically changes while drilling and the structure may not be constant, the LWD measurements and nearby wellbore measurements may be correlated in segments or blocks of constant or similar dip and initial elevation (TVD). The foregoing methodology has been proved to be effective in many cases, but is subject to certain limitations. One of the limitations is that the correlation is made in only one dimension (TVD or TST) and therefore could sometimes be very difficult, possibly leading to an incorrect structural interpretation. Incorrect structural interpretation may result in the well trajectory being placed outside the desired formations. Such placement may result in reduced wellbore productivity or increased production of undesirable materials (e.g., water) from a particular wellbore.

What is needed is an improved method for geosteering and determining formation properties adjacent a deviated wellbore to assist in determining wellbore construction and/or completion parameters.

### SUMMARY OF THE INVENTION

A method according to one aspect of the invention for formation structural interpretation while drilling a wellbore through subsurface rock formations includes interpreting rock formation strata with respect to measurements of a formation physical property made with respect to depth in an offset wellbore. A color is assigned to each of a plurality of selected value ranges of the measurements. The physical property of the formation is measured while drilling the wellbore through the subsurface rock formations. A color is assigned to the measurements made while drilling based on the assigned color to each of the selected value ranges. The assigned colors made while drilling are used to estimate a stratigraphic position of the wellbore during the drilling by comparing the assigned colors made while drilling to the colors assigned from the offset wellbore.

In another aspect, the color plots may be used to determine properties of the formations surrounding the wellbore at selected axial positions in order to better determine wellbore construction and/or completion parameters.

Other aspects and advantages of the invention will be apparent from the following description and the appended claims.

### BRIEF DESCRIPTION OF THE DRAWINGS

FIG. 1 shows an example of measurement while drilling (MWD) and logging while drilling (LWD), the measurements from which may be used in example methods according to the invention.

FIGS. 1A, 1B and 1C show, respectively, an initial stratigraphic interpretation from an offset well and a color scale interpretation of formation measurements generated therefrom; a changed stratigraphic interpretation by matching the colors associated to the LWD measurements and offset well logs; and further structural interpretation as wellbore drilling proceeds along a path laterally away from the surface position of the wellbore.

FIG. 2 shows the final interpretation of LWD measurements to determine wellbore stratigraphic position by using the color scale correlation and its resultant true vertical depth (TVD) match of the converted LWD measurements.

FIG. 3 shows another example of color scale, while-drilling interpretation of LWD measurements to determine wellbore stratigraphic position.

FIG. 4 shows a color scale generated prediction of formation properties based on properties of formations in an offset wellbore and the trajectory of a deviated wellbore within the identified and structurally interpreted formation layers (strata). Predicted property curves are shown at the top of the chart in the figure.

FIG. 5 shows an example of wellbore mechanical design for hydraulic fracturing based on interpretation of stratigraphic position of the well from color plots.

FIG. 6 shows an example of actual fracture treatment (frac) results that can be integrated with structural interpretation generated on plots such as shown in FIG. 4. Formation and fracture treatment parameters can be displayed as histograms, curves, or numerical values along the deviated wellbore trajectory.

FIG. 7 shows an example of multiple-source data cross plotting.

### DETAILED DESCRIPTION

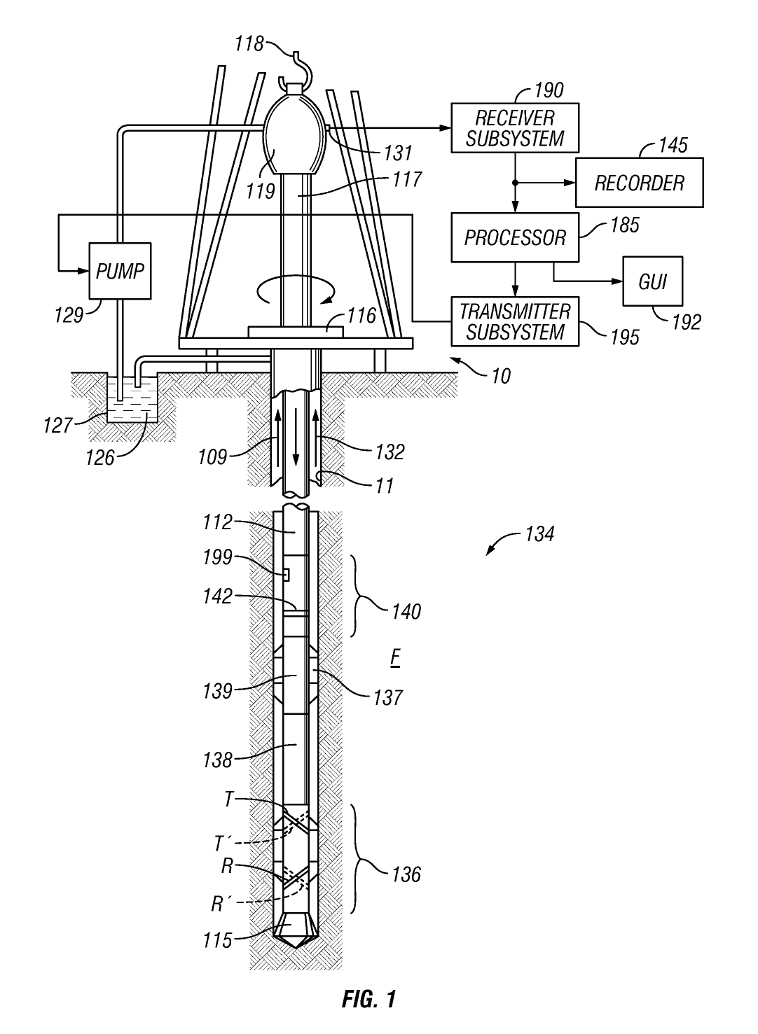

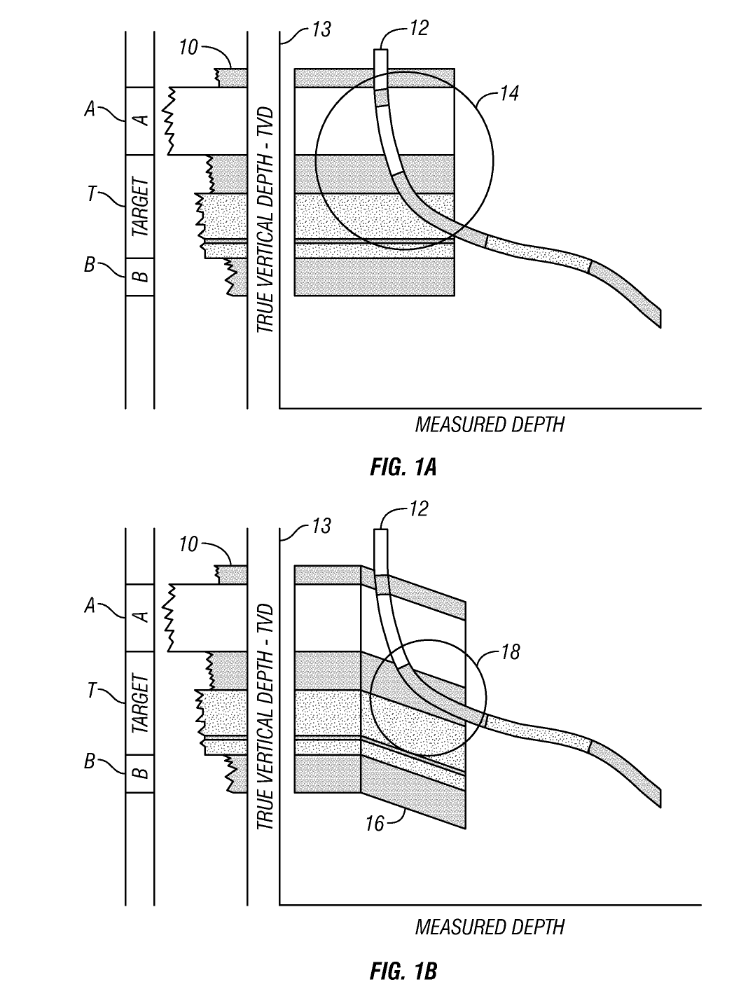

FIG. 1 illustrates a drilling rig and a drill string in which an instrument for making measurements during wellbore drilling may be used in methods according to the present invention can be used. A land-based platform and derrick assembly 110 are shown positioned over a wellbore 111 penetrating subsurface rock formations F. In the illustrated example, the wellbore 111 is formed by rotary drilling in a manner that is well known in the art. Those of ordinary skill in the art given the benefit of this disclosure will appreciate, however, that the present invention finds application in directional drilling applications, for example, using rotary steerable directional drilling systems or “steerable” hydraulic motors. Further, the invention is not limited to land-based drilling but is equally applicable to marine based wellbore drilling.

A drill string 112 is suspended within the wellbore 111 and includes a drill bit 115 at its lower end. The drill string 112 may be rotated by a rotary table 116, energized by means (not shown) which engages a kelly 117 at the upper end of the drill string 112. The drill string 112 is suspended from a hook 118, attached to a traveling block (also not shown), through the kelly 117 and a rotary swivel 119 which permits rotation of the drill string 112 relative to the hook 118. It will be appreciated by those skilled in the art that the invention is not limited to kelly driven drill strings. Top drives (not shown) may also be used.

Drilling fluid or mud 126 is stored in a pit 127 formed at the well site or a tank. A pump 129 delivers the drilling fluid 126 to the interior of the drill string 112 via a port in the swivel 119, inducing the drilling fluid to flow downwardly through the drill string 112 as indicated by the directional arrow 109. The drilling fluid 126 exits the drill string 112 via jets or courses (not shown) in the drill bit 115, and then circulates upwardly through the annular space between the outside of the drill string 112 and the wall of the wellbore 111, (called the “annulus”), as indicated by the direction arrows 132. In this manner, the drilling fluid 126 cools and lubricates the drill bit 115 and carries formation cuttings up to the surface as it is returned to the pit 217 for recirculation.

The drill string 112 further includes a bottom hole assembly, generally referred to at 134, near the drill bit 115 (in other words, within several drill collar lengths from the drill bit). The bottom hole assembly 134 includes instruments in the interior of drill collars or similar tubular devices in the drill string having capability for measuring, processing, and storing information, as well as communicating with the surface. The bottom hole assembly (“BHA”) 134 thus may include, among other devices, a measuring and local communications apparatus 136 for determining and communicating resistivity of the formations F surrounding the wellbore 111. The measuring device and local communications apparatus 136, also known as a “resistivity tool”, includes a first pair of transmitting/receiving antennas T, R, as well as a second pair of transmitting/receiving antennas T″, R″. The second pair of antennas T″, R″ are symmetric with respect to the first pair of antennas T, R, as is described in greater detail below. The resistivity tool 36 further includes a controller (not shown separately) to control the acquisition of data, as is known in the art.

The BHA 134 may further include instruments housed within certain drill collars 138, 139 for performing various other measurement functions, such as measurement of the natural radiation, density (gamma ray- or neutron-type), and fluid pressure in pore spaces of the formations F. At least some of the drill collars may be equipped with stabilizers 137.

A surface/local communications subassembly 140 may also be included in the BHA 134, just above one of the drill collars shown at 139. The subassembly 140 includes a toroidal antenna 142 used for local communication with the resistivity tool 136 (although other known local-communication means may be employed to advantage), and a known type of acoustic telemetry system that communicates with a similar system (not shown) at the earth's surface via signals carried in the drilling fluid or mud. Thus, the telemetry system in the subassembly1 40 includes an acoustic transmitter that generates an acoustic signal in the drilling fluid (a.k.a., “mud-pulse”) that is representative of measured downhole parameters.

The generated acoustical signal is received at the surface by pressure transducers represented by reference numeral 131. The transducers, for example, piezoelectric transducers, convert the received acoustical signals to electronic signals. The output of the transducers 131 is coupled to a surface receiving subsystem 190, which demodulates the transmitted signals. The output of the receiving subsystem 190 is then coupled to a computer processor 185 and a recorder 145. The computer processor 185 may be used to determine the formation resistivity profile (among other formation parameter profiles) on a “real time” basis, that is, while logging is underway, or subsequently by accessing recorded data from the recorder 145. The computer processor 185 can be coupled to a monitor 192 that uses a graphical user interface (“GUI”) through which the measured downhole parameters and particular results derived therefrom (e.g., resistivity profiles) are graphically presented to a user.

A surface transmitting system 195 may also be provided for receiving input commands and data from the user (e.g., via the GUI 192), and is operative to, for example, selectively interrupt the operation of the pump 129 in a manner that is detectable by transducers 199 in the subassembly 140. In this manner, there may be two-way communication between the subassembly 140 and the surface equipment. A suitable subassembly 140 is described in greater detail in U.S. Pat. Nos. 5,235,285 and 5,517,464, both of which are incorporated herein by reference. Those skilled in the art will appreciate that alternative acoustic techniques, as well as other telemetry means (e.g., electromechanical, electromagnetic), can be employed for communication with the surface.

Methods according to the invention may be performed on the processor 185, wherein suitable programming therefor is provided. The method may also be performed on any other processor, using either remote transmission of date from the location of the wellbore re received at the surface, or from communication of date from the recorder 145 to another processor (not shown).

Generally, methods according to the present invention complement true stratigraphic thickness (“TST”) and/or true vertical depth (“TVD”) curve correlation known in the art with a two-dimensional correlation using specific colors associated with the values or magnitude of measurements made in a wellbore while drilling. In methods according to the invention, measurements of one or more petrophysical properties may be obtained from one or more nearby (“offset”) wellbores, and colors may be assigned to the measurements therefrom based on, for example, a unique color associated with values of the measured parameter being within selected magnitude ranges.

The ability to estimate formation structure using colors associated to measurements values from nearby wellbore(s), called “type curves”, and to display the drilling well trajectory with colors associated with logging while drilling (“LWD”) measurements made as explained with reference to FIG. 1, using the same color associations as the type curves enables the user to make a visual correlation of colors that facilitates interpretation of the structure of the formations so as to produce a match between the colors. Color match may be associated with maintaining the stratigraphic position of the wellbore within a selected stratum or selected strata in the subsurface. The foregoing color match procedure provides a second dimension of correlation to the one dimensional TST and/or TVD correlation known in the art. It is within the scope of the present invention to perform the color matching in the processor 145 or in another processor using the type curve(s) and LWD measurements made as explained above.

In the several following figures, different colors are represented by various infill patterns and shading for simplicity of the drawings. It will be apparent to those skilled in the art that actual colors on a color display or printer may be selected in a similar manner to the shading and infill used to represent colors in the several figures.

FIGS. 1A, 1B and 1C show, respectively:. (a) an initial interpretation of formation structure from an offset well and a color scale interpretation of formation measurements generated therefrom; (b) a changed stratigraphic interpretation by matching the colors associated to the LWD and offset well logs; and (c) further structural interpretation as wellbore drilling proceeds along a path laterally away from the surface position of the wellbore

In FIG. 1A, measurements made, for example, from an offset wellbore may be used to generate an interpretation of the elevation and dip of particular rock formations or layers (“strata”). Measurements of one or more petrophysical properties may be used to generate a type curve for the offset wellbore(s), shown generally at 10. Specifically, a “type curve” may be described as a particular set of measurement values with respect to elevation (depth) that may be associated with a particular stratum. Examples of measurements that may be used include, without limitation, physical properties of the rock formations such as natural gamma radiation, electrical resistivity, neutron porosity and/or capture cross section, gamma backscatter density and acoustic velocity (shear and/or compressional). A set of measurements of the physical property that changes with respect to depth may be uniquely associated with particular strata by reason of the shape of a curve drawn or interpolated through such measurements when displayed as values with respect to depth. It should be noted that such type curves may be generated by visual interpretation by the user, or may be generated using a computer program designed to perform such interpretation, either in the processor (145 in FIG. 1) or another processor or suitably programmed computer.

The type curves 10 in the present example are shown in the TVD domain. It will be appreciated by those skilled in the art that the type curves 10 may be obtained from a wellbore that is drilled vertically or that is not drilled vertically, that is, the type curves may be measured in the “measured depth” domain and converted to the TVD domain using a deviation survey or wellbore trajectory survey.

The type curves 10 may be further interpreted, for example, by using ranges of measurement values of one or more petrophysical parameters measured over the same TVD intervals in the offset well, the shape of the type curves, and combinations of measurement values of more than one petrophysical parameter so that specific stratigraphic zones having selected aggregate properties may be identified. Examples of such identified stratigraphic zones are shown in FIG. 1A (as well as FIGS. 1B and 1C) at A, T, B and C.

In the present example, the magnitude or similar attribute of the physical property measurements made in the offset well may be used to produce a color scale display as shown in FIG. 1A. The color assigned to selected depth intervals from the offset well may correspond, for example, to predetermined ranges of the value of the measurement. As non limiting examples, one color may be selected for electrical resistivity in the range of 0.2 to 1 ohm-m, another color may be selected for values of electrical resistivity in the range of 1 to 2 ohm-m, etc. Similar color selection corresponding to value ranges may be generated for any other measured formation parameter and for selected ranges of values thereof.

During the drilling of the wellbore, one or more LWD measurements of formation physical properties corresponding to the measurements made in the offset well may have their values determined and caused to generate a color corresponding to the color association made for the offset well, e.g., a unique color for selected ranges of values of the measured physical parameter. It should also be noted that in order to compare the colors associated with different types of measurements (e.g., and without limitation, cross comparing gamma ray and neutron porosity), the LWD measurements may have to be normalized, and different color palettes and scales may be implemented to emphasize certain structural features.

In a method according to the invention, the well path trajectory in “measured depth” domain (lower scale 14 in FIG. 1A) is plotted against the TVD domain (scale 13 in FIG. 1), and the LWD measurement curves are displayed along this well path trajectory, shown at 12, may be correlated to the background projection of type curve colors 10 from the nearby wellbore in order to determine the stratigraphic position of the wellbore. The magnitude or other attribute of the LWD measurement(s) may be associated with a color representative of each range of values as selected for the measurements made in the offset well, as explained above. Note that in FIG. 1A, the colors generated from the LWD measurements 12 compared to the nearby wellbore type curve colors in the background 10 do not substantially match. It may be inferred, therefore, that the interpreted structure (e.g., change in layer depth with respect to geodetic position) of the rock formations (F in FIG. 1) does not correspond to the trajectory of the wellbore.

FIG. 1B shows a revised interpretation of the structure of the formations with respect to lateral position away from the surface location of the wellbore, shown at 16. Such revised interpretation may be facilitated by matching the assigned color sequence of the offset wellbore to the assigned color sequence generated by the LWD measurements. FIG. 1C shows a continuation of a structural cross-section 20 of the structural interpretation made by color comparison in FIG. 1B.

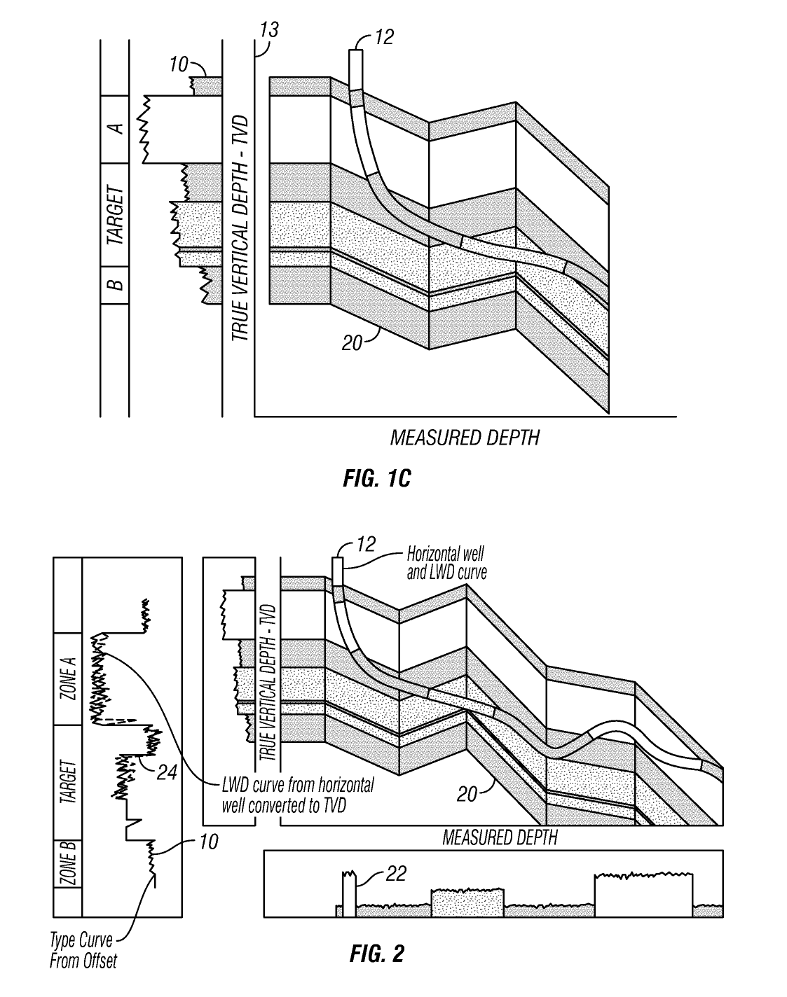

FIG. 2 shows a continuation of the structural interpretation of FIG. 1C, with the addition of its resultant true vertical depth (TVD) correlation of the converted LWD measurements 24 to the offset type curves 10 on the left hand side of the figure, and with a measured depth color scale 22 shown on the bottom of the figure. In a specific example, a trajectory determined prior to drilling the wellbore may be adjusted so that the wellbore remains within one of more selected strata (e.g., as shown at T).

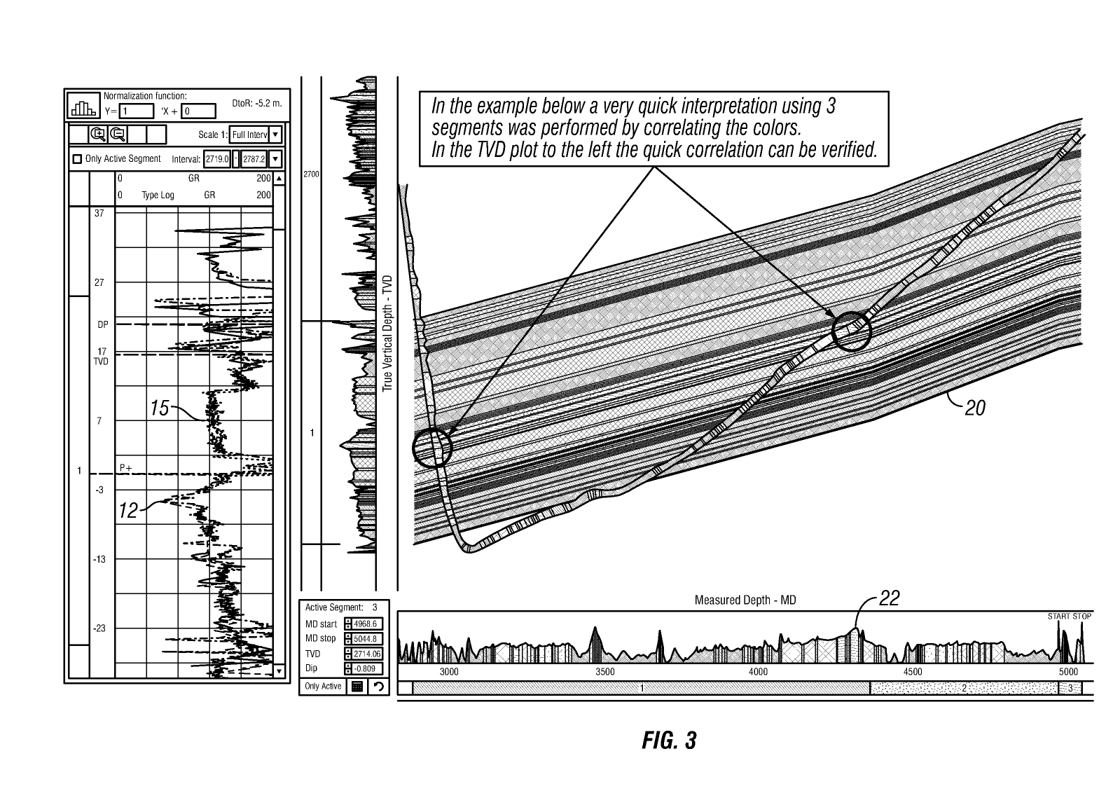

Another example is presented in FIG. 3. In the example shown in FIG. 3, a structural interpretation was performed by correlating the colors at the indicated points shown at 26 (right part). After reviewing one dimensional TVD correlation of the type curve 10 and the TVD domain-transformed LWD curve 15, an acceptable match between the type curve 10 and the transformed LWD curve 15 can be established (see the left hand side of the figure). If the colors do not match between the offset well and the transformed LWD measurements, a structural cross section 20 of the formations being traversed by the drilling wellbore may be adjusted so that the color sequence from the LWD measurements matches the color sequence from the offset well type curve (10 in FIG. 2).

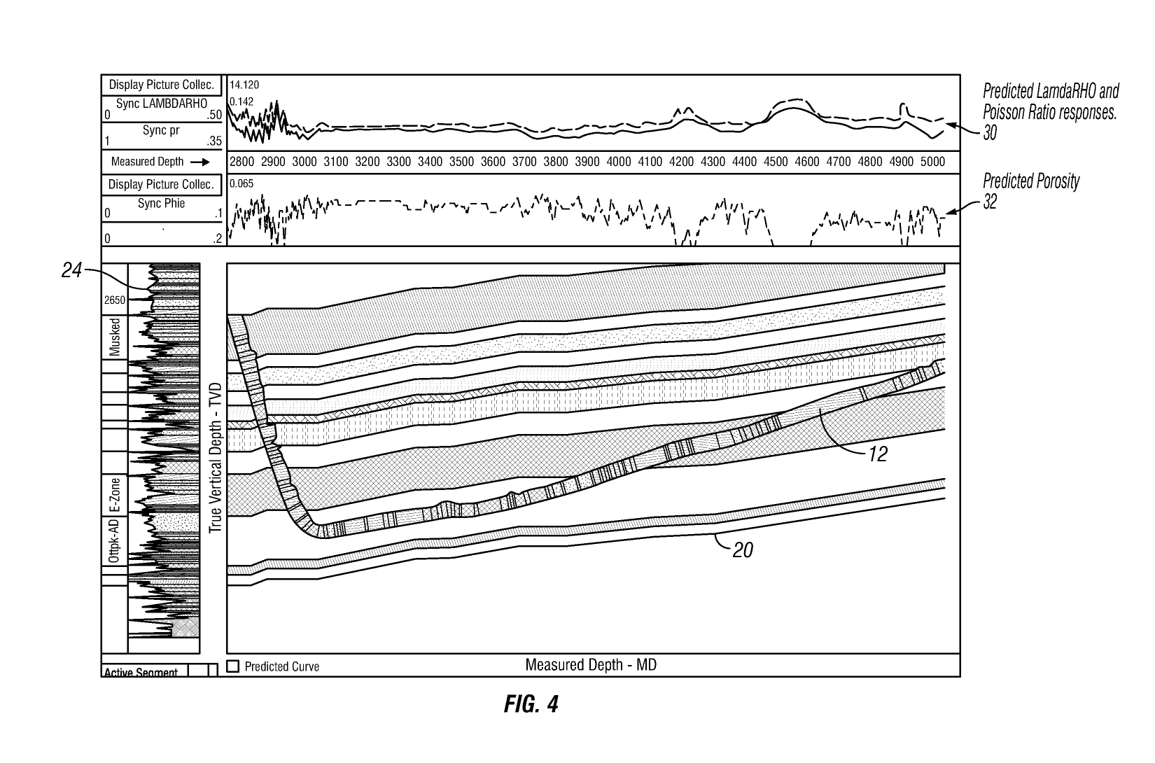

FIG. 4 shows an example of one or more selected petrophysical or other formation properties, shown at curves 24, in the offset well being extrapolated to any point along the length of the directionally drilled well according to its interpreted stratigraphic position, shown at curves 30 and 32. The extrapolation curves 30, 32 along the length of the deviated well enables generating predicted petrophysical property curve(s) with respect to measured depth (axial position) along the deviated well. Such curve(s) can be individual sample values or an average of several samples in the vertical direction. Such predicted response curve(s) can be useful when designing completion procedures (e.g., running and cementing casing and designing and optimizing single or multi-stage hydraulic fracturing. The predicted petrophysical property curve(s) 30, 32 may also be used to evaluate expected wellbore response, e.g., fluid production types and rates from the subsurface formations penetrated by the deviated well. Such prediction may be performed in the processor (145 in FIG. 1) or in another processor or suitably programmed computer.

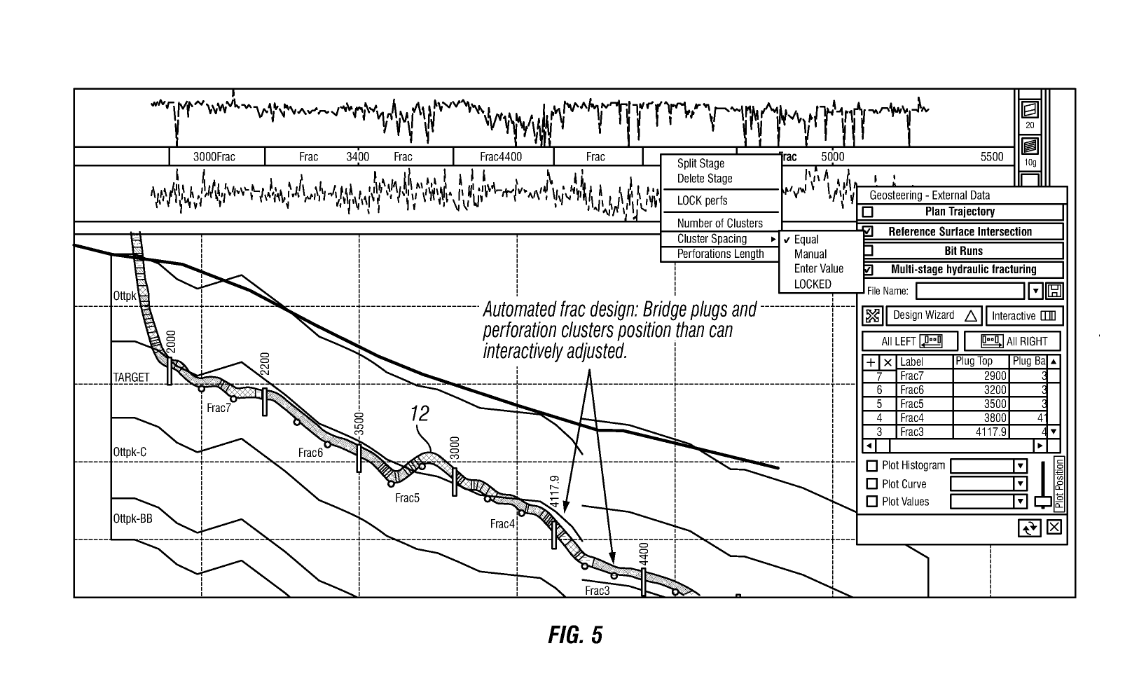

FIG. 5 shows an example plot of hydraulic fracturing designed and interactively edited in a single display, wherein all the available petrophysical and other wellbore data can be integrated into a single plot for facilitating the fracture design and accompanying wellbore mechanical features. Such formation properties can include, for example, synthetic stress curves, fault interpretation, drilling parameters, etc. The location of mechanical devices such as bridge plugs and perforation clusters can be interactively located using the displayed formation properties with respect to position along the length of the deviated wellbore.

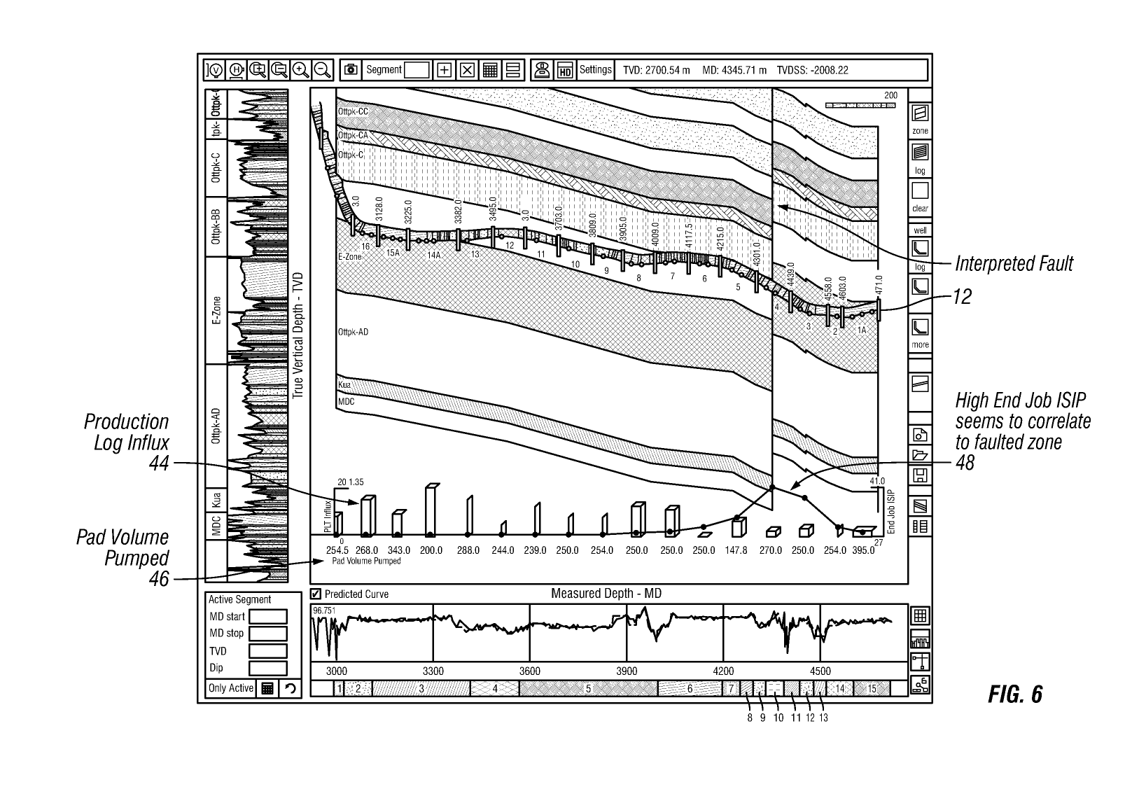

FIG. 6 shows an example of actual fracture treatment (frac) results that can be integrated with structural interpretation generated on plots such as shown in FIG. 4. Formation and fracture treatment parameters can be displayed as histograms 44, curves 48, or numerical values 46 along the directionally drilled wellbore trajectory (curve 12).

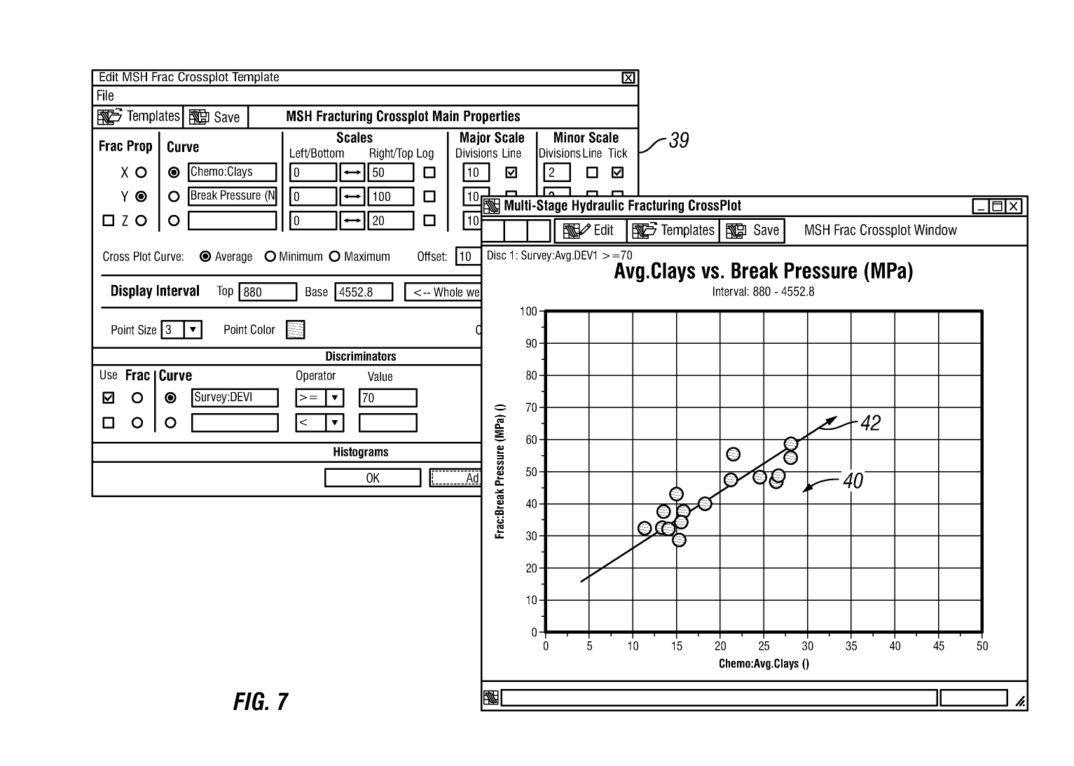

FIG. 7 shows an example of multiple source data cross-plotting. The display in FIG. 7 integrates wellbore completion parameters, wellbore fluid production data, well log data, structural interpretation, and any other available data that can be displayed in one cross-plot. Any two parameters can be cross-plotted, and in some examples, a third parameter can be added to the cross plot, for example, by selection of a unique color or symbol code for the individual cross plotted data points representative of the value of the third plotted parameter. The cross plot may include best fit curve calculation and plotting routines, e.g., linear least squares best fit, polynomial best fit or any other technique to develop best fit curves representative of the cross-plotted data. In the case of three parameter cross plots, a unique color or curve code may be generated for each value of the third parameter in the cross plot. Such features may facilitate understanding of well performance, fracture treatment results and optimization. An example data entry screen (which may be displayed on the GUI (192 in FIG. 1) is shown at 39 in FIG. 7 and may be part of the programming of the processor (145 in FIG. 1) or another processor or computer.

The cross-plot functionality shown in FIG. 7 allows automatic extraction of any curve values, for example, in each perforated wellbore interval and can compute an average, minimum, or maximum, that may be cross-plotted, shown at 40, against any other data curve, fracture treatment parameter, or production data associated with the corresponding perforated interval or cluster. A best fit curve 42 may be calculated for the cross-plot 40 to assist in predicting a value of one of the cross-plotted parameters for any other cross-plotted parameters where there are no data from the offset well or the LWD measurements or other measurements. The best fit curve 42 may be generated on the processor (145 in FIG. 1) from, for example, linear least squares best fit or polynomial best fit.

The cross plot functionality also allows defining an offset (from the pilot or offset well) distance at the beginning and ending of each perforated interval to extend the interval in which the corresponding well log properties may be extracted for average, minimum, or maximum value calculation.

Methods according to the invention may provide improved interpretation of geologic structure of subsurface rock formations during wellbore drilling and may improve the ability of a wellbore driller to maintain the wellbore trajectory within selected subsurface formations. Such improved ability may improve the productivity of certain wellbores of commercially valuable materials such as hydrocarbons while reducing production of undesirable materials such as water.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for formation structural interpretation while drilling a wellbore through subsurface rock formations, comprising:
interpreting, on a processor, rock formation strata with respect to measurements of a formation physical property made with respect to depth in an offset wellbore;
assigning, on a processor, a color to each of a plurality of selected value ranges of the measurements;
measuring the formation physical property while drilling the wellbore through the subsurface rock formations;
assigning, on a processor, a color to the measurements made while drilling based on the assigned color to each of the selected value ranges; and
using the assigned colors made while drilling to estimate a stratigraphic position of the wellbore during the drilling by comparing the assigned colors made while drilling to the colors assigned from the offset wellbore.

2. The method of claim 1 further comprising displaying the assigned colors with respect to measured depth of the wellbore while drilling.

3. The method of claim 1 further comprising adjusting a predetermined trajectory of the wellbore while drilling to maintain a wellbore trajectory within at least one selected rock formation.

4. The method of claim 1 further comprising adjusting a structural interpretation of the rock strata with respect to lateral displacement from a selected surface position based on causing the colors assigned during drilling to the colors assigned from the measurements made in the nearby wellbore.

5. The method of claim 1 further comprising displaying values of at least one formation parameter with respect to position along the wellbore based on the estimated stratigraphic position after the wellbore drilling is completed, the values displayed as curves with respect to lateral distance from the offset wellbore.

6. The method of claim 5 further comprising displaying hydraulic fracture treatment parameters with respect to the lateral distance, the hydraulic fracture treatment parameters comprising at least one of mechanical wellbore device locations, synthetic stress, interpreted faults and drilling parameters.

7. The method of claim 6 further comprising displaying at least one of produced fluid inflow volume into the wellbore and fracture fluid pumped into the wellbore with respect to the lateral distance.

8. The method of claim 1 further comprising displaying at least two selected wellbore or formation parameters with respect to lateral distance as a cross-plot.

9. The method of claim 8 further comprising including at least a third parameter in the cross plot using a color or symbol code for the at least a third parameter.

10. The method of claim 8 further comprising generating a best fit curve through the cross-plot.

11. The method of claim 9 wherein the best fit curve comprises at least one of linear least squares best fit and polynomial best fit.
